(19) United States
(12) Patent Application Publication
(10) Pub. No.: US 2023/0268869 A1
(43) Pub. Date: Aug. 24, 2023

(54) ENERGY STORAGE CANOPY WITH ELECTRIC VEHICLE CHARGE COMPONENTS

(71) Applicant: LT350, LLC, Longmont, CO (US)

(72) Inventor: Jeffrey Thramann, Longmont, CO (US)

(21) Appl. No.: 18/142,336

(22) Filed: May 2, 2023

Related U.S. Application Data
(63) Continuation-in-part of application No. 17/946,660, filed on Sep. 16, 2022, now abandoned.
Application No. 17/946,660 is a continuation of application No. 16/876,905, filed on May 18, 2020, now Pat. No. 11,476,796.
Application No. 16/876,905 is a continuation of application No. 16/118,679, filed on Aug. 31, 2018, now Pat. No. 10,666,188.
Application No. 16/118,679 is a continuation of application No. 15/007,140, filed on Jan. 26, 2016, now Pat. No. 10,069,456.
Application No. 15/007,140 is a continuation-in-part of application No. 14/678,476, filed on Apr. 3, 2015, now Pat. No. 9,647,300.
Application No. 14/678,476 is a continuation-in-part of application No. PCT/US14/58671, filed on Oct. 1, 2014.
(60) Provisional application No. 63/425,779, filed on Nov. 16, 2022.
(60) Provisional application No. 61/885,897, filed on Oct. 2, 2013.

(51) Int. Cl. H02S 20/24; F24S 25/40; F24S 25/10; H02S 40/38; H02S 20/23; H02S 20/10; E04H 6/06

(52) U.S. Cl. CPC H02S 20/24; F24S 25/40; F24S 25/10; H02S 40/38; H02S 20/23; H02S 20/10; E04H 6/06; F24S 2025/014

(57) ABSTRACT

An energy storage canopy having solar panels and an energy storage cartridge to charge electric vehicles or the like is provided. The energy storage cartridge includes a power connector that has a power cord with a plug assembly configured to electrically could the battery of an electric vehicle to the energy storage cartridge.

### CROSS-REFERENCE TO RELATED APPLICATIONS

The present application claims priority from and the benefit of U.S. Provisional Patent Application No. 63/425,779, entitled “ENERGY STORAGE CANOPY WITH ELECTRIC VEHICLE CHARGE COMPONENTS,” filed Nov. 16, 2022 and is a continuation-in-part of U.S. patent application Ser. No. 17/946,660, entitled “METHODS FOR LOADING BATTERY STORAGE COMPARTMENTS INTO A SOLAR CANOPY SUPPORT STRUCTURE,” filed Sep. 16, 2022, which is a continuation of U.S. patent application Ser. No. 16/876,905, filed May 18, 2020, now U.S. Pat. No. 11,476,795, which is a continuation of U.S. patent application Ser. No. 16/118,679, filed Aug. 31, 2018, now U.S. Pat. No. 10,666,188, which is a continuation of U.S. patent application Ser. No. 15/007,150, filed Jan. 26, 2016, now U.S. Pat. No. 10,069,456, which is a continuation-in-part of U.S. patent application Ser. No. 14/678,476, filed Apr. 3, 215, now U.S. Pat. No. 9,647,300, which is a continuation-in-part of PCT/US2014/58671, filed Oct. 1, 2014, which claims the benefit of U.S. Provisional Application 61/885,897, filed Oct. 2, 2013, the contents of each of which are incorporated by reference in their entireties for all purposes.

### BACKGROUND

As countries become more concerned with oil reserves, renewable energy and carbon footprints become a focus of attention. Grid power, local power networks, and/or standalone loads attempt to address some of the concerns with renewable energy sources as well as changes in rates based on the demands for energy (also known as on-peak rates and off-peak rate). However, renewable energy sources are inherently unpredictable in their output. For example, wind energy is necessarily dependent on the wind speed and direction in some cases. Solar energy is influenced by the time of day, weather conditions, and the like. Also, rate changes between on-peak demand and off-peak demand have a limited effect on the overall demand for energy during peak or on-peak demand hours as the larger consumers are typically corporations that have a limited ability to vary their energy demands. Additionally, large scale renewable energy farms, such as wind turbine farms and large solar arrays are traditionally coupled to the grid power network remote from any particular residential or commercial center. Thus, problems with the traditional or conventional power grid disrupts the renewable energy power source in a manner similar to the disruption of any power.

For most industrial countries, refrigeration systems, which include high volume air conditioning (HVAC) systems and refrigeration systems, such as food storage systems, are among some of the larger consumers of power from the grid or local power network. The large electrical power demand is generally due to the compressor used to compress the working fluid.

Also, as gas prices and concerns over emissions of gas/diesel powered vehicles increases, individuals and businesses (a/k/a consumers) are turning to electrical cars, trucks, and the like, generally electric vehicles. As electrical vehicles come online, and if they become concentrated in an area, additional stresses may be put on the power grid. Also, most consumers would prefer to charge vehicles at off peak rates in view of the large amount of electricity they potentially require.

In part, in view of the above, it is desirable to provide an energy storage canopy or system that stored, and/or locally used, electrical energy and refrigerant (sometimes referred to as thermal) energy using renewable sources and/or off-peak demand power to reduce the demand for energy at on-peak demand times. Additionally, the energy storage canopy can be used to charge electric vehicles using largely renewable energy sources.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a solar canopy is provided. The solar canopy comprises, among other things, a high capacity battery integrated into or retrofitted to the solar canopy. The solar canopy would, through a power conditioner or directly, charge the high capacity battery, which may include specially design high capacity batteries, or one or more electrical vehicle battery (or batteries). The high capacity battery (or batteries) contained in the solar canopy would be electrically coupled to retractable power cord that contains a plug assembly at a distal end. The plug assembly would have a plug (or socket) that mates with a socket (or plug) of an electric vehicle. The power cord may have a pull string coupled to the power cord to allow a user to extend the power cord. The power cord may be coupled to a spring loaded wheel/gear that retracts the power cord into a holder when the power cord is disengaged. The power cord may be held by an articulated arm in certain embodiments. The high capacity battery, or batteries, would supply the stored electrical energy by to the battery of the electric vehicle. While the high capacity battery, or batteries, can be charged by the solar panels over time, in certain embodiments the solar canopy is coupled to the power grid to facilitate charging electric vehicles when the high capacity battery, or batteries, does not have sufficient energy stored to charge the electric vehicle. In certain aspects, the solar canopy charges the electric vehicle battery using the high capacity battery as an energy source when grid power is at peak rates. In certain aspect of the technology, a plug assembly on the power cord will have a display, such as, for example, a touchscreen or other digital display. The display will provide information regarding the charge delivered to the electric vehicle, total price of the charge, rate, etc. The plug component in certain embodiments may have a card reader, via RF technology, chip technology, or strip, to receive credit card or other payment information, such as ApplePay, GooglePay, SamsungWallet, or the like. Also, the display may have a keyboard associated with it so the owner of the electric vehicle may be able to enter account information for bank fund transfers or accounts with the solar canopy charging company. In some aspects, the technology may be provided such that the solar canopy uses the power grid rather than the stored energy in the high capacity batteries, such as, when the high capacity batteries are at a low amount of stored energy, grid power demand is low or a non-peak rates, etc. In still other aspects, the technology may be provided as a standalone unit without connection to any grid power, which would be useful for areas without wide access to grid power or areas, perhaps, where natural disasters have disabled grid power.

In certain aspects of the technology, the plug component, or another part of the solar canopy, may have a radio frequency transmitter. The radio frequency transmitter may establish a communication link with a smart device of an electric vehicle driver or processor(s) of the electric vehicle. The processor may transmit the data regarding the electric vehicle charging, such as charge delivered and total cost, to the smart device of the driver such that the information is displayed by the smart device. In certain aspects, the electric vehicle charging data is transmitted to the processor of the electric vehicle such that the electric vehicle display displays the data.

In certain aspects of the technology, the power cords retract and a draw cord hangs from the plug component or the like such that a driver, when a person or robot, can grasp the draw (pull) cord and extend the power cable such that the plug of the plug component can be connected to the electric vehicle socket. In certain embodiments, the plug component may have the socket while the electric vehicle has the plug.

In certain aspects of the technology, the power cord is coupled to an articulating arm that rotates, angulates, and pivots in multiple degrees to align the power cord and plug component with the socket of the electric vehicle. In certain aspects, the power cord and plug component may be driven by a motor, such as a servo or the like, to automatically align with the socket of the electric vehicle. To facilitate alignment, the plug component may include optics coupled to the processor to allow the processor to align the plug component with the socket. The plug component may comprise a plurality of plugs to fit a plurality of sockets for different electric vehicles. To identify the different electric vehicles, for plug socket configurations and/or location of the socket on the electric vehicle, the solar canopy may have an optics to identify the electric vehicle, by recognition, scanning the electric vehicle VIN (vehicle identification number), or input by the driver.

In some aspects of the technology, an energy storage canopy is provided. The energy storage canopy may be operationally coupled to a local building, or directly to particular loads, such as, for example, the battery of an electric vehicle, to provide energy reserves to reduce or supplant the electrical energy needs of the charging the electric vehicle and to use energy from the battery during on-peak demand times, which are times when energy companies provide energy at a higher cost.

In some embodiments, the energy storage canopy has at least one vertical and at least one horizontal support on which a roof is provided. The energy storage canopy further includes support members, typically horizontal, that can support compartments. The compartments may be integral with or removable from the energy storage canopy. The compartment comprises, among other things, a plurality of high capacity batteries to store electrical energy, which energy may be received from an integrated renewable energy source, such as a solar array or a wind turbine system. The compartment allows for coupling high capacity batteries to the battery of an electric vehicle such that the high capacity batteries can supply power to electric vehicle battery.

In certain aspects of the technology, the solar canopy also includes a package system configured in certain embodiments to work with drones. The package system includes lockers. The lockers may be used for the delivery of packages. Radio frequency keys or combinations are provider to drivers (or other users) via their smart device. When configured with drones, the top surface of the solar canopy includes a package delivery zone, a package retrieval zone, and a charging zone for the drones. The zones may have movable solar panels over the zones such that when a drone is not using the zone, a solar panel may be deployed over the zone to maximize the solar panel surface area. The package delivery zone is proximate a package arrival (or delivery) elevator. In operation, the drone delivers the package to the delivery zone and the package is moved to the package arrival elevator. The drone either lands over the package arrival elevator or a conveyor transports the package form the drone to the package arrival elevator. The package is then moved by the package delivery elevator to the appropriate locker. The drone retrieves a package from the retrieval zone in a similar manner. The package to be retrieved is to be placed in the package departure (retrieval) elevator. The drone either aligns with the package retrieval zone over the package departure elevator or a conveyor transfers the package from the package departure elevator to the package retrieval zone that is proximate the package departure elevator. The charging zone is a landing pad for the drones that has an induction charging plate to charge the drone's battery from the stored energy. In some embodiments, a cover may rotate about the plurality of zones to protect the drone/package from the elements.

These and other aspects of the present system and method will be apparent after consideration of the Detailed Description and Figures herein.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a perspective view of a solar canopy consistent with the technology of the present application.

FIG. 1A is a view of a solar canopy consistent with the technology of the present application with a different structural configuration than FIG. 1.

FIG. 2 is a view of the underside of the roof of the solar canopy of FIG. 1 consistent with the technology of the present application

FIG. 2A is a view of an energy storage cartridge and a power connector consistent with the technology of the present application in isolation for convenience.

FIG. 3 is an exemplary computer or server usable for the various computers, processors, servers, edge servers, or the like consistent with the technology of the present application.

FIG. 4 is an exemplary graphical user interface on a display associated with a monitor or the like consistent with the technology of the present application.

FIG. 5 is a perspective view of the solar canopy of FIG. 1 with additional services consistent with the technology of the present application.

FIG. 6 is a detail of a drone and elevator platform of FIG. 5 consistent with the technology of the present application.

FIG. 7 is a detail of a locker assembly, elevator, elevator platform and drone of FIG. 5 shown in isolation for convenience.

FIG. 8 is a detail of a drone charging platform consistent with the technology of the present application.

FIG. 9 is a detail of another energy storage cartridge consistent with the technology of the present application.

FIG. 10 is a detail of a grid edge server cartridge in isolation consistent with the technology of the present application.

FIG. 11 is a perspective view of the solar canopy of FIG. 1 with additional peripheral callouts consistent with the technology of the present application.

FIG. 12 is a view of a solar canopy of FIG. 1 with kiosks and housings consistent with the technology of the present application.

FIG. 13 is a schematic diagram of electrical connections of the solar canopy of FIG. 1 consistent with the technology of the present application.

FIG. 14 is a detail of a portion of a thermal storage cartridge consistent with the technology of the present application.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to photovoltaic cells (a/k/a solar panels), commercial refrigeration systems, grid power as a load, electric vehicles as a load, local power networks as a load, combinations thereof, and the like. However, the technology described herein may be used with applications other than those specifically described herein. For example, the technology of the present application may be applicable to wind generation systems, server farms, home air conditioning systems, morgue refrigeration systems, or the like. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

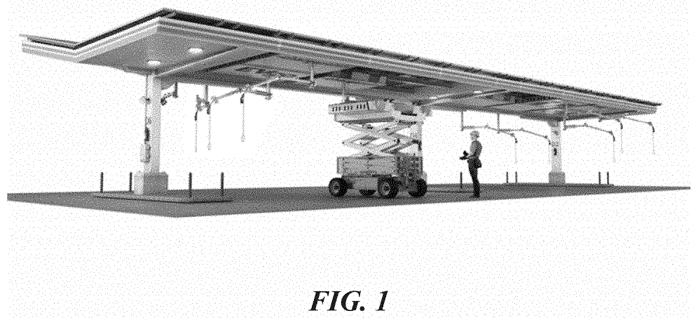

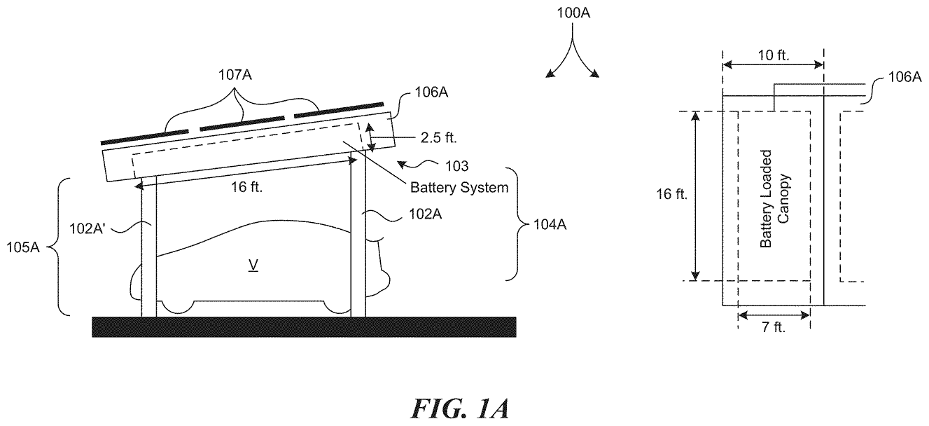

With reference now to FIG. 1, a solar power canopy 100 is shown. Solar power canopy 100 is shown with a central support structure 102 comprising a vertical strut 104 having an exposed portion (not specifically labeled) and a buried portion (not specifically shown in the figures). The buried portion may be below ground or connected to a foundation of a building, parking lot, etc. In other words, the buried portion may alternatively be a flanged connection to a foundation or some other connection. The central support structure 102 further has two horizontal support struts 110 extending from the vertical strut 104. The vertical strut 104 and two horizontal support struts 110 form a generally “T” shaped support structure, or in certain embodiments and inverted L shape. When an inverted L shape, the structure may have a single horizontal support strut 110. As shown, the horizontal support struts 110 form a generally “V” shape although flat or an inverted “V” shape among other shapes are possible. A roof 112 is formed over and supported by the horizontal support struts 110. Arranged on the roof 112 are photovoltaic panels 114, which are sometimes referred to as solar panels or simply panels. The panels 114 may be directly mounted to the roof 112 or raised to provide a ventilation gap G between the roof 112 and panels 114 to facilitate heat dissipation. Other heat dissipation structure or means include, for example, vents, fans, and the like. While a specific vent, such as a slot or opening, facilitates air movement, vent should be construed broadly herein as a structure that allows the passage of air or air flow. In other words, not hermetically sealing the cavities provides that the seams formed where parts abut may provide sufficient air flow to allow the seam to act as a vent. The panels 114 may be mounted in a fixed position to the roof 112 or mounted to allow for angulation, sliding movement, or rotation. The movement may be to allow the panels to track the suns progression through the day or the time of year, or the movement may be to allow access to a portion of the canopy roof as explained further herein.

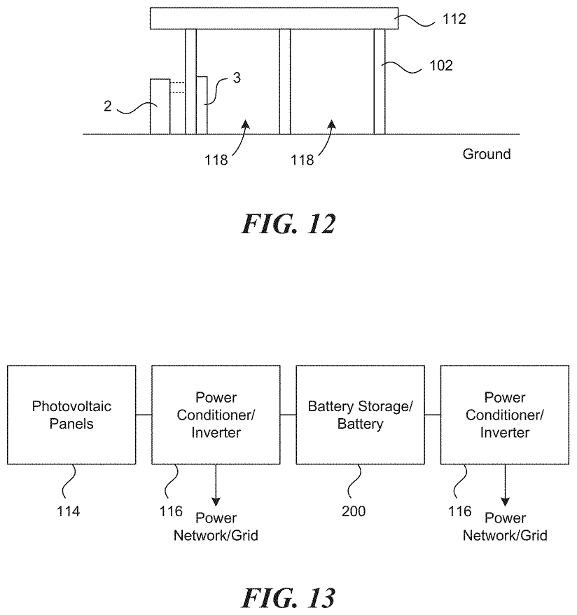

The panels 114 gather light and output electricity. The panels 114 may be coupled to a power conditioner as describe in U.S. Pat. No. 9,647,300, incorporated herein as if set out in full, which may condition the power for coupling to a power grid, residential power network, or a local load, such as through retractable power cords 212 shown in FIG. 1 and explained further below. The technology of the present application is configured to supply electrical power from the solar power canopy 100, and possibly via the solar panels directly, via the high capacity batteries directly, or via a combination thereof to an external unit, which external unit may be an electrical vehicle battery or other load. In certain embodiments, the power grid may be coupled to the solar canopy 100 such that the grid power can supply energy when the local resources are insufficient. The power conditional may include a power control system (or PCS), computer processors (such as computers described below) or servers (such as grid edge servers explained below), an inverter, a converter or transformer, or the like (some of which are shown below for completeness). Power conditioners to provide electrical energy from renewable energy sources to loads will not be further explained except as necessary for a complete understanding of the technology of the present application. With reference to FIG. 12, a view of an exemplary solar canopy 100 is shown with a standalone kiosk 2 or a housing 3 is shown. The standalone kiosk 2 or housing 3 could contain the power conditioning equipment, inverters, transformers, energy storage cartridges, other cartridges, computers, and servers as explained further below. The kiosk 2 also may include a processor to provide a graphical user interface and/or a credit card (or other electronic payment means) equipment as explained below. The kiosk 2 and housing 3 would have an electrical conduit connecting them the solar canopy 100 to allow wires and cables to connect energy storage cartridges, solar panels 114, power conditioning units, inverters, transforms, etc. to the kiosk 2 and housing 3. So shown in FIG. 12, the solar canopy 100 may include vehicle bays 118, some specific types of vehicles bays are explained further herein.

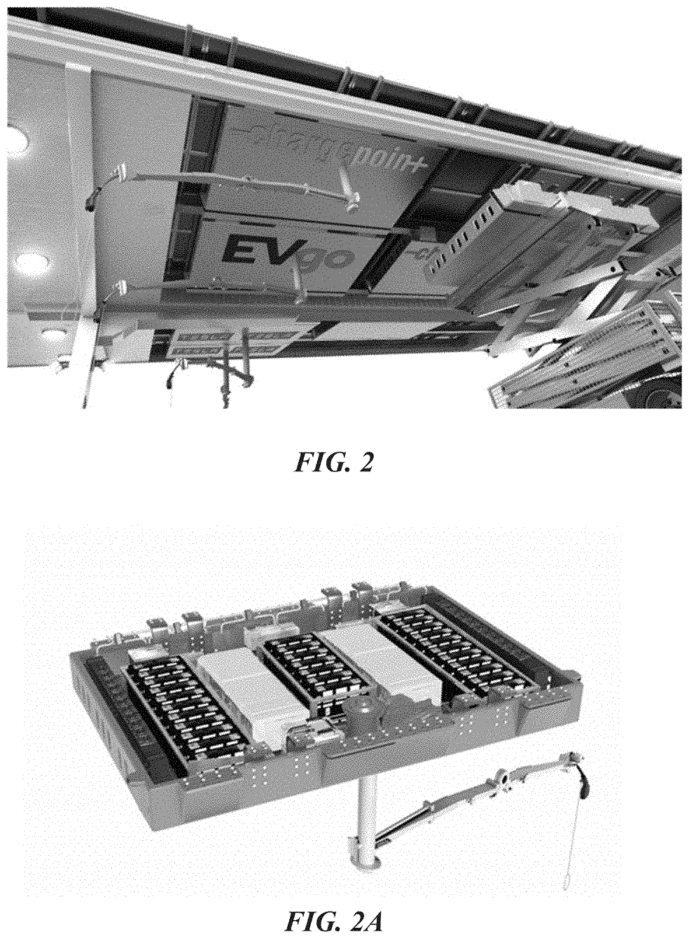

As can be seen in FIG. 1, solar canopy 100 is a solar canopy 100 specifically for electric vehicle battery charging, although solar canopy 100 as explained below does not have to be dedicated to electric vehicle battery charging. Be that as it may, the exemplary solar canopy 100 shown here has a number of electric vehicle charging stations 120, which are specifically designed vehicle bays 118. FIG. 2 shows a view of solar canopy 100 wherein the view is looking upwards from under the roof 112 of solar canopy. The roof 112 has an inverted V-shape and shows 4 electric vehicle charging assemblies 202, one electric vehicle charging assembly 202 would be used for one electric vehicle charging station 120. The electric vehicle charging assemblies 202 have surfaces 203 that may be used for advertisement and the like. In certain embodiments, the surface 203 may include one or more digital displays. The electric vehicle charging assemblies 202 include an energy storage cartridge 204 (or electric vehicle charge cartridge 204), which may be removable as shown by the energy storage cartridge 204 being moved by a lift 206, and at least one power connector 208 operatively coupled to the energy storage cartridge 204 for each electric vehicle charging assembly. The cartridge 204, as seen in FIG. 2A, may include batteries, power conditioning equipment, and a power control systems as needed for the individual unit, or the cartridge 204 may be integrated with other cartridges to provide certain features. While a single power connector 208 is shown for each energy storage cartridge 204, in certain embodiments, each energy storage cartridge 204 may have multiple power connectors 208. Also, the power connector 208 may be mechanically coupled to the solar canopy 100 in locations other than the energy storage cartridge 204.

As seen in FIGS. 2 and 2A, the power connector 208 includes an articulating arm 210 and a retractable power cord 212 extendible from and retractable into the articulating arm 210. The power cord 212 is electrically coupled to the high capacity battery in the energy storage cartridge 204 at a proximal end 214 of the power cord 212 and coupled to a plug assembly 216 at a distal end 218 of the power cord 212. FIG. 2A shows a perspective view of the energy storage cartridge 204 and power connector 208 in isolation. As can be seen in FIG. 2A, the energy storage cartridge 204 comprises a plurality of rechargeable batteries B (a.k.a storage batteries B). The energy storage of the plurality of rechargeable batteries B is typically more than the energy required to fully charge at least two (2), and preferably, at least three (3) or more electric vehicle batteries although more or less energy storage is possible. The plug assembly 216 includes a plug (or socket) 220 sized to fit a socket (or plug) of an electric vehicle in the electric vehicle charging station 120. The plug assembly 216 also may include a display 221, which may be a graphical user interface as will be explained further below.

The articulating arm 210 may include an anchor portion 222, an upper arm portion 224, an intermediate arm portion 226, and a lower arm portion 228. The anchor portion 222 in this exemplary embodiment is a vertical sleeve 230 that terminates in a rotatable coupling 232. The upper arm portion 226 is coupled to the rotatable coupling 232 such that the upper arm portion 226 is able to rotate about an axis extending vertically through the vertical sleeve 230. In some embodiments, the rotatable coupling also allows the upper arm portion 226 to pivot and rotate, similar to ball and socket joint. The upper arm portion 226 is coupled to the intermediate arm portion 226 at a first joint 234. The first joint 234 is envisioned to be a hinge joint to allow the intermediate arm portion 226 to pivot with respect to the upper arm portion 224 (or, conversely, the upper arm portion 224 pivots with respect to the intermediate arm portion 226), but the first joint 234 may be a ball and socket joint or the like to allow additional degrees of freedom. The lower arm portion 228 is coupled to the intermediate arm portion 226 at a second joint 236. The second joint 236 is envisioned to be a hinge joint to allow the intermediate arm portion 226 to pivot with respect to the lower arm portion 228 (or, conversely, the lower arm portion 228 pivots with respect to the intermediate arm portion 226), but the second joint 236 may be a ball and socket joint or the like to allow additional degrees of freedom. Each of the upper arm portion 224, intermediate arm portion 226, and lower arm portion 228 may be a single tubular member or a plurality of telescoping members. The upper arm portion 224, intermediate arm portion 226, and lower arm portion 228 may be hollow to allow the power cord 212 to traverse internal to the arms. While shown with an intermediate arm 226, in some embodiments, the upper arm portion 224 and the lower arm portion 228 are coupled together without an intermediate arm 226. Also, in some embodiments, there are multiple intermediate arms 226 between the upper arm portion 224 and the lower arm portion 228.

The first joint 234, second joint 236, the rotating coupling 232, and/or all, a combination of, or none of them may be biased, such as, for example, a spring hinge, to lift the articulating arm 210 towards the roof 112 when the not in use. To facilitate using the articulating arm 210, a pull member 238 may be coupled to the distal end of the lower arm portion 228. Pulling the pull member 238 allows a user to lower the articulating arm 210.

The power connector 208 in certain embodiments may comprise the retractable power cord 212 extending directly from the energy storage cartridge 204 and terminating in a plug assembly 216. In this case, the pull member 238 would be coupled to the retractable power cord 212 proximal the plug assembly 216 such that the retractable cord 212 could be extended from the energy storage cartridge 204.

The distal end of the power cord 212 extends from the opening 240 on the distal end of the lower arm portion 228. The distal end 218 of the power cord 212 terminates in the plug assembly 216. The power cord 212 is a flexible cord such that a user, or driver, can align the plug 220 with the socket of the electric vehicle. In some embodiments, the power cord 212 may extend from the energy storage cartridge 204 to the plug assembly 216. In other embodiments, the power cord 212 may only extend only from the lower arm portion 228, intermediate arm portion 226, or upper arm portion 224 rather than the energy storage cartridge 204. In such a case, a conductor extends from the end of the power cord to the energy storage cartridge to couple the plug assembly 216 to the batteries B. In some embodiments, the plug assembly may include a plurality of plugs 220 (or a plurality of sockets, or a combination of a plurality of plugs and a plurality of sockets) to accommodate different connections to different batteries that are to be charge by the electric vehicle charging stations 120. While consumer and commercial vehicles are described in the present application, other batteries could and likely would be charged using the solar canopy 100.

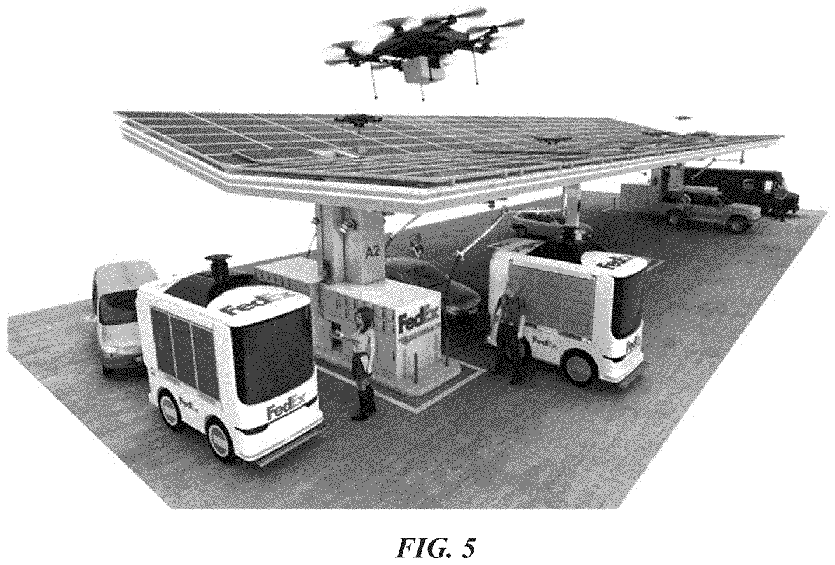

In use, for example, a driver (or user) would drive an electric vehicle EV, see FIG. 5, into one of the electric vehicle charging stations 120. The driver would exit the vehicle and pull the pull member 238 such that the articulating arm 210 descends. The driver may need to rotate the articulating arm 210 about the rotating coupling 232. The driver would extend the power cord 212 from the opening 240 and plug the plug 220 of the plug assembly 216 into the socket of the electric vehicle EV, see FIG. 5.

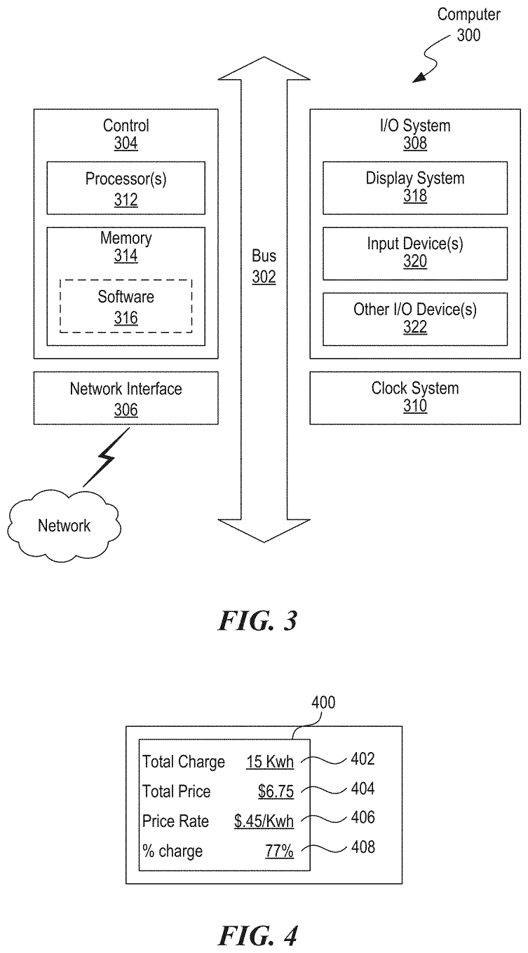

In some embodiments, the rotating coupling 232, first joint 234, and second joint 236 may be controlled by a motor, or multiple motors, such as one or more servo motors or the like. The motors would be controlled by a joystick or a computer 300, which computer may be a server, edge server, microprocessor, or the like, as shown in FIG. 3. In certain embodiments, the computer to control the various functions as described throughout the application would be incorporated into one or more servers, or grid edge servers, incorporated into the canopy 100 as described further below. FIG. 3 is a block diagram of a computer to implement the motor controlled articulating arm 210 according to some embodiments of the present disclosure. The computer may be designed to execute instructions to cause the motors to rotate the rotating coupling 232 and pivot one or both first and second joints 234 and 236 either individually or in unison to align the plug assembly 216, and specifically the plug 220, with the socket of the electric vehicle. The computer 300 may be a sever, a grid edge server, a desktop computer, a laptop computer, a system on a chip (SOC), a single board computer (SBC) system, a mainframe, a mesh of computer systems, a handheld or mobile device, or the like.

The computer 300 includes a bus 302 that is operable to transfer data between hardware components. The components include a processor 304, such as a CPU or microprocessor, a network interface 306, an input/output (I/O) system 308, a clock system 310. The input/output system 308 may receive input from location sensors on the plug assembly 216 and the output single may drive the motors such that the rotating coupling 232, first joint 234, and second joint 236 move the plug assembly 216 to a determined location for the electric vehicle EV corresponding socket. To facilitate some of the communication described herein the computer 300 may include as part of the I/O system 308 one or more radio frequency transceivers (or separate receivers and transmitters).

In some embodiments, the plug assembly 216 may include an optical unit that provides input to the I/O system 308. The processor 304 would process the optical input and determine how to move the articulating arm 210 such that the plug 220 aligns with the electric vehicle EV socket. In certain embodiments, the electric vehicle charging station 120 may include a reader to scan (or otherwise acquire) the VIN number of the electric vehicle EV. The processor 304 would identify the make and model of the electric vehicle EV from the VIN. The processor 304 would have a known location of the electric vehicle EV socket, and the processor 304 would drive the motors such that the plug 220 aligns with the known location of the socket. In yet other embodiments, the processor 304 may connect wirelessly with a smart device of the driver of the electric vehicle EV and the driver would use a control application (such as one containing directional arrows or the like) to provide signals to the processor 304 to drive the articulating arm 210. These, as well as other, means for driving the articulating arm 210 to automatically cause the plug 220 to electrically couple with the electric vehicle EV socket are possible.

The I/O system 308 also receives input from sensors electrically coupled to the power cord or upstream from one or more of the cartridges associated with the solar canopy 100. The sensors may sense the rate of energy (such as amps or kilowatts per unit of time), total accumulated energy transfer (such as for example a percentage of battery charge or kilowatt/hours), and the like. The I/O system 308 may also receive information from a sensor in the plug assembly 216 (or located elsewhere) that determines the charge or energy capacity of the electric vehicle EV battery, which may be a percentage such that 0% is fully drained and 100% is fully charged). The processor 304 would receive the inputs and output through the I/O system 308 to a display information/data for the driver of the electric vehicle. Typically the information/data to be displayed would be charge or price data. As shown in FIG. 4, the display may be a graphical user interface (GUI) 400 on a monitor or computer display. While more, less, or other information is possible, the exemplary GUI 400 may display the following charge and/or price data, total charge delivered 402 (FIG. 4 for example displays 15 kwh of total charge delivered), total price 404 (FIG. 4 for example displays $6.75 for total price), price rate 406 (FIG. 4 for example displays $0.45/kilowatt hour (with a typical price range between about $0.25/kwh and $0.80/kwh), and percentage charge of the electric vehicle battery 408 (FIG. 4 displays the EV battery at 77% total charge). The GUI 400 may be a touch screen or the like to receive input from the driver, such as credit card or account information. The GUI 400 may be incorporated into a display on the plug assembly 216, communicated to a smart device of the driver, or communicated to a display mounted in the electric vehicle EV. In certain embodiments, the electric vehicle charging station 120 include a credit card reader or other device to accept payment form Apple pay, Google pay, Samsung wallet, or the like. The credit card reader or other device may be incorporated into the plug assembly in some embodiments. In other embodiments, the display, such as GUI 400, credit card reader, or other devices may be incorporated into the kiosk 2 or housing 3 associated with the electric vehicle charging stations as described above. In still other embodiments, the electric vehicle charging station 120 may be staffed by an attendant similar to a conventional gas station to control payment, charging, and the like or some combination thereof.

With reference to FIG. 5, another aspect of the solar canopy 100 is provided. Solar canopy 100 may be a logistic center for receiving or sending packages, such as, for example, a package 501 being carried by a drone 502 or a package 503 being carried by a person 504, or possibly, a robot 504.

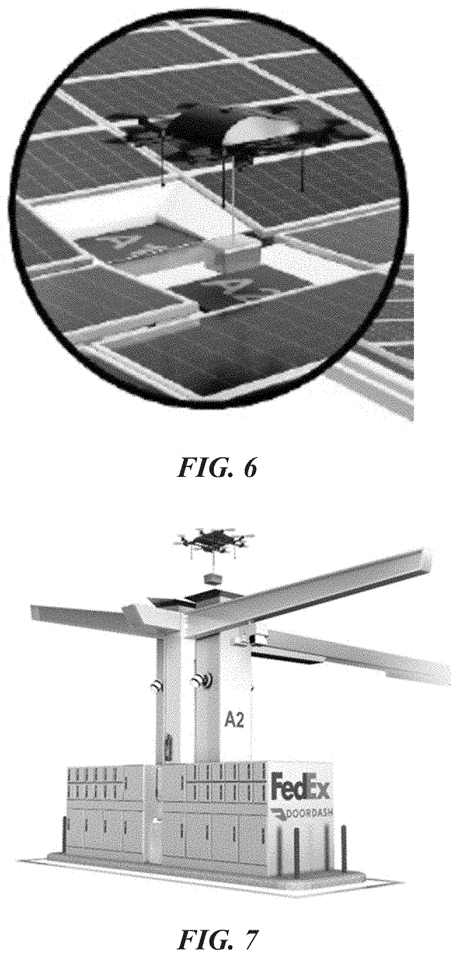

The solar canopy 100 is shown receiving and/or sending packages 501 by drones 502. FIG. 6 shows a detail of the drones 502 delivering a package 501 at the arrival locker assembly 506, which include a plurality of individual lockers 507. The drone 502 would carry the package 501 to an elevator platform (or receiving pad) 508. The elevator platform 508 may be on an arrival elevator 510 (or simply an elevator 510). As shown in FIG. 7, the solar canopy 100 has two arrival elevators 510, designated as 510_{A1} and 510_{A2} in this example. While two elevators are shown, more or less are possible. Also, as explained below, the solar canopy 100 will have one or more departure elevator 511 (FIG. 5) with an elevator platform. In certain aspects of the technology, each elevator may be both an arrival elevator and a departure elevator. In other embodiments, the arrival elevators are used only for package arrivals and the departure elevators are used only for departing packages. The drone 502 would be programmed with delivery instructions that include, for example, a location for the solar canopy 100, an elevator 510 at the solar canopy to receive the package 501, a locker 507, and (optionally) a lock code to allow a recipient of the package to open the locker 507. The drone 502 also may be programmed with pick up instructions, especially if the drone 502 originates at the solar canopy 100. It is envisioned that the drones 502 may depart and return to the solar canopy 100, depart from one solar canopy 100 and arrive at another solar canopy 100, or arrive at a solar canopy from a 3rd party location. The drone 502 would deliver package 501 to the appropriate elevator, which is elevator 510_{A2} in this example. The drone may receive its programming instructions from processors controlling the logistics, a.k.a. logistics processors. The drone 502 would also transmit delivery instructions to the processors controlling the logistics, which may include computer 300 as described above.

After the package drop off, the logistics processors would cause the elevator platform 508 to descend the elevator shaft to the level of the locker 507. The processors controlling the logistics would next cause conveyors, such as conveyor belts, in the arrival locker assembly 506 to move the package 501 to the locker 507 and deposit the package 501 in the locker 507. The delivery instructions include, among other things, identification information for the recipient of the package 501. The recipient information may include a cellular telephone number or user identification that allows the processors controlling the logistics to transmit a message to the recipient, which message may be transmitted via a phone call, a text message, an email, a short message service, or other transmission. The message to the recipient would include, among other things, the solar canopy 100 location and locker 507 identification. The message may also include a lock code, which may be a combination or a radio frequency lock code to a mobile smart device that the recipient can use to unlock locker 507. The recipient may the person to which the package is supposed to be delivered or a delivery service 512, such as, FedEx® or UPS® to name but two (2) possible services. Also, while a person 504, or robot 504, is shown transferring the package from the locker 507 to the delivery service 512, in certain embodiments, the delivery service may include an autonomous vehicle that has a means for retrieving the package from the locker 507.

Similarly, but in reverse, to send a package, a user would communicate to the logistic processors, for example, the computer 300, a pickup request and delivery instructions. The computer 300 would transmit an assigned locker 507 into which the user would place the package 501. The computer 300 would coordinate with a delivery service 512 or drone 502 to retrieve the package. If a delivery service 512, the delivery service 512 would pick up the package as defined above. If a drone, the assigned drone 502 would land on an elevator platform 508 associated with a departure elevator 511, which is shown on the opposite side of the canopy 100 in FIG. 5, however, other locations for the elevators, lockers, and stations are a matter of design choice. Also, each elevator may be an arrival and a departure elevator as a matter of design choice. The computer would cause the conveyers to move the package from the locker 507 to the elevator platform 508 whereupon the drone 502 would grasp the package for delivery.

With reference back to FIG. 6, a movable solar panel 600 is shown. The movable solar panel 600 is mounted on elements 602, such as sliders, casters in a channel, linkage assemblies, or other means to move the solar panel, that allow solar panel 600 to move laterally (or pivot) with respect to other solar panels 114. When a drone 502 is not accessing the elevator platform 508, the movable solar panel 600 covers the elevator platform 508. When a drone 502 needs to access the elevator platform 508, the logistics processors cause a motor, or other drive means, to move the solar panel 600 to uncover the platform 508. The movable solar panel 600 may move on elements 602 to slide on rails as shown, lift and rotate on a linkage assembly, or pivot up and down. Movable solar panel covers the platform 508 when a drone does not need to access the platform to allow for more surface area to collect light and generate energy to charge the batteries or otherwise convert solar power to electrical energy. When the platform 508 is uncovered, the movable solar panel 600 may cover certain solar panels 114, either wholly or partially, or, in the alternative, the movable solar panel 600 may move under solar panel 114 rather than over solar panel 114 as shown. If the moveable solar panel 600 pivots, or the like, it simply may not have sufficient surface area to be incident to the light to produce energy.

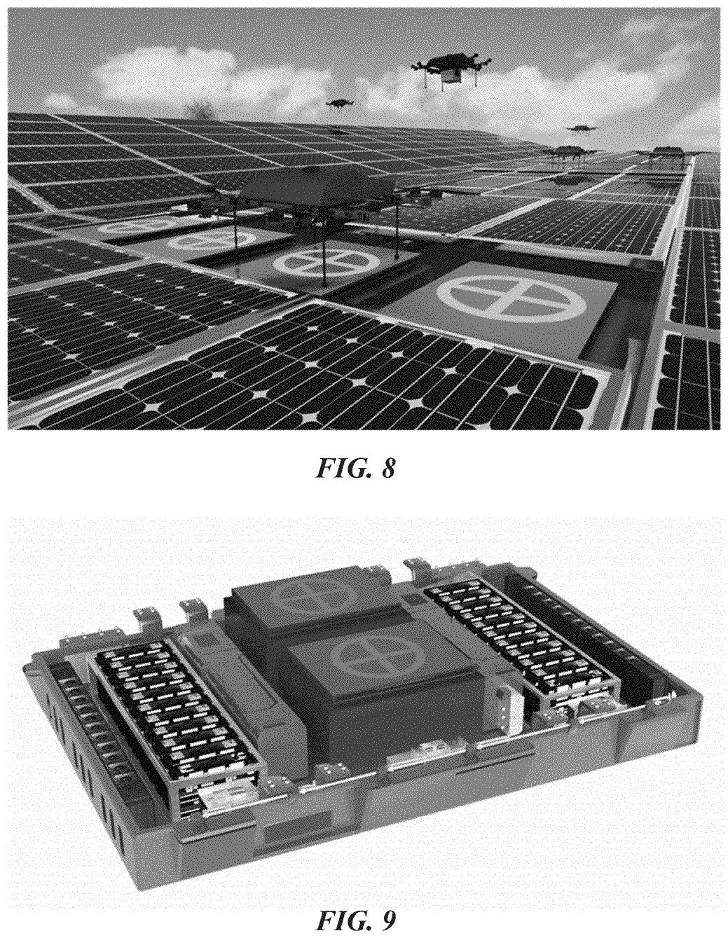

Drones 502 have limited flying range and time due to energy use. FIGS. 8 and 9 show an aspect of solar canopy 100 capable of facilitating use of drones 502. As shown in FIG. 8, the solar canopy 100 may have a plurality of charging platforms 610. FIG. 8 shows a series of four (4) charging platforms 610, but as few as one (1) charging platform is possible. Additionally, the total number of charging platforms 610 is limited by available space. The charging platforms 610 are envisioned to be inductive charging pads such that the drone 502 simply needs to land on the charging pad 610. In certain embodiments, however, the drone 502 may need to align with a plug or power connector to receive a charge. The charging pads 610 are electrically coupled to the batteries B of the energy storage cartridge 204. FIG. 9 shows a drone charging cartridge 611 with batteries B in which the charging pads 610 are integrally mounted although in the normal course the charging pads 610 are likely separate from the energy storage cartridge and connectable via a power conductor. The drone charging cartridge 611 in some embodiments is a specially designed energy storage cartridge 204.

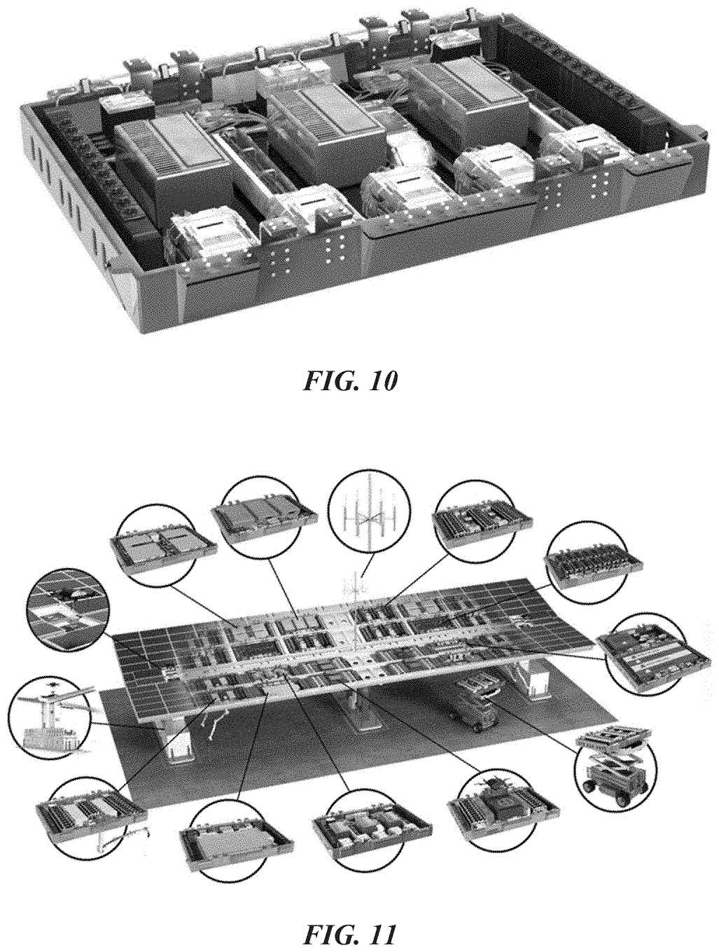

The logistic processors, such as the computer 300 described above, controlling the drones 502 and delivery services 512 require the processing and transmission of a large amount of data and may use a large amount of throughput, especially when logistic processors provide flight paths for the drones 502 or the delivery services 512 are autonomous. The data processing requirements and throughput may strain available communication bandwidth, especially in more remote locations. Thus, the solar canopy 100 solves the throughput and data processing issues by providing processor and servers, such as the logistic processor cartridge 615 shown in FIG. 10. The logistic processor cartridge 615 has a number of processors, such as described above with respect to FIG. 3, and include multiple computers or servers, which may be considered edge servers. The logistic processor cartridge 615 is a specific type of grid edge computing cartridge that holds the routers, servers, etc. specifically for the pickup and drop off logistics (a.k.a PICKDROP LOGISTICS).

FIG. 11 shows a perspective view of the solar canopy 100 explaining a wider array of peripherals, some of which are explained further above. For example, solar canopy 100 includes the elevator platforms 508 for the drones 502.

The solar canopy 100 also includes power conditioners, which condition the energy from the solar panels or batteries for the various services, such as power to computers, electric vehicles, drones, lights, cameras (security or otherwise), and the like. The power conditioners include among other things a solar inverter cartridge 650 and a transformer cartridge 651.

The In certain embodiments, the solar canopy 100 may include a retractable cell tower 652. The retractable cell tower would have a retractable antenna 653 and a retractable remote radio head 654. The tower stanchion 656 would typically be hollow to allow for a conductor to a base station (which may be mounted in a cartridge on the solar canopy or in a kiosk or other housing proximate the solar canopy 100).

FIG. 11 also shows a battery storage cartridge 658. The battery storage cartridge 658 may store energy to supplement a grid power connection or supply power to certain of the peripheral devices, such as, for example, the retractable cell tower 652. The battery storage cartridge 658 is a type of energy storage cartridge 204 described above

The solar canopy 100 may also include a plurality of grid edge server cartridges 659. The grid edge server cartridges 659 can be used for a variety of functions. For example, the grid edge server cartridges 659 may be used for mining crypto currencies. The solar canopy 100 in some embodiments is ideal to house crypto mining servers as the servers can be cycled on and off as required to provided power as required to other services, such as, for example, the logistics processors described above or the grid when additional grid power is necessary.

As is explained further in U.S. Pat. No. 10,587,015, which is incorporated herein by reference as if set out in full, the solar canopy may include a thermal storage cartridge 660. The thermal storage cartridge 660 may include a compartment for the pumps and controllers and a compartment for the refrigerant and thermal energy exchangers or the like.

FIG. 11 also shows the scissor lift 206 with a removable cartridge 204, which is an energy storage cartridge in this example, but could be any cartridge described herein. For example, the scissor lift 206 may lift the drone charging cartridge 611 or the logistic processor cartridge 615, which is a specially designed grid edge server cartridge 659. Consistent with the logistic processor cartridge 615, FIG. 11 shows the locker assembly 506 and elevators 510.

FIG. 11 also shows the electric vehicle charging cartridge 204, which includes the power connector 208. The electric vehicle charging cartridge 204 is a specially designed battery cartridge or energy storage cartridge.

FIG. 11 also provides an EV battery storage cartridge 665 that is a specifically designed battery storage cartridge 658. The EV battery storage cartridge 665 is designed to house a battery from an electric vehicle when those electric vehicle batteries reach end of useful life for the electric vehicle. The EV battery is retains a majority of its energy storage capability. The EV battery storage cartridge 665 is shown with a Tesla battery, although the EV battery storage cartridge 665 may be designed to house any EV battery.

With reference to FIG. 1A, another embodiment of a solar canopy 100A is shown in a side elevation and partial top view. The solar canopy 100A includes vertical supports 102A and 102A′. Beams 103A (not specifically shown) extend laterally and longitudinally between the vertical supports 102A and 102A′. As shown, the solar canopy 100A has an entry side 104A where the vertical support 102A has a longer length than the terminal side 105A support 102A′, which allows for angulation of a roof structure 106A supported by vertical supports 102A and 102A′, and beams 103A. Generally, angulation of the roof structure 106A provides for better solar reception of photovoltaic cells 107A or panels. The photovoltaic panels 107A are typically raised from the roof to allow for ventilation. The solar canopy 100A may be sized similar to the dimensions as shown in FIG. 1A, which is generally sized to fit a parked vehicle V. The dimensions, however, are exemplary and should not be considered limiting.

As described above, the solar canopy 100 may include a retractable cell tower 652. However, in certain aspects, the retractable cell tower 652 may be a satellite antenna in certain embodiments or other type of radio frequency antenna. Also, the solar canopy 100 may have multiple retractable antenna to allow for combinations thereof. The retractable cell tower 652 would be electrically coupled to a power source such as, for example, the energy storage cartridge 204 and be powered electrically from either the solar panels 114, a high capacity battery (or batteries), or the power network such as a power grid or residential power network to allow for radio communication. In certain embodiments, a backup electrical generator may provide emergency power to the solar canopy 100. This is especially useful in emergency conditions, such as, for example, relief efforts for hurricanes, humanitarian aid for disaster zone, war zones, and the like, when a power grid or residential power network in unavailable.

The batteries referred to in the application are high capacity batteries. In certain embodiments, the high capacity batteries may be specially designed. In some cases, the high capacity batteries may be batteries from an electrical vehicle, such as is available from Tesla, Nisson, or the like. One of ordinary skill in the art would recognize on reading the disclosure that such a high capacity battery is configured to store at a minimum approximately 75-100 kWh (kilo watt hours) of power. Generally, the term high capacity battery as used herein stores at least 100 kWh to 150 kWh, but higher and lower capacity batteries are contemplated by the technology of the present application. Generally, the minimum capacity for the technology of the present application would be approximately 10 kWh. The high capacity battery may be of many types including lithium ion, lead acid, and the like to name but two (2) types of batteries. As can be appreciated, high capacity batteries in the magnitude of 10 or more kWh produce a significant amount of heat that must be dissipated by a heat dissipation system, as will be further explained below.

As more fully described in the applications and patents incorporated by reference above, the solar canopy 100 may include one or more heat dissipation systems. Fans and vents may be used singularly or in conjunction with means for dissipating heat depending on the kWh of the batteries. For example, it is possible that simple air cooling will not be sufficient for the high capacity batteries described herein. Simple air cooling generally refers to convection to ambient air. The heat dissipation system may include heat exchangers, a pump etc., to facilitate fluid flow for cooling of the battery or cartridges. The means for dissipating heat may also include forced air systems, which would include fans and compressors as well as pumps, etc.

As shown in FIG. 13, the solar panels 114 may output power directly to the external unit, such as the power network, grid, electric vehicle battery, or any of the other devices mentioned throughout the application regardless of whether a battery is placed in the system. Similarly, the high capacity battery (or energy storage cartridge 204) may output power directly to the external units, such as the power network, grid 1 or local power network, electric vehicle battery, or any of the other devices mentioned throughout the application regardless of a connection to another power supply.

The technology of the present application, however, is scalable to a very high voltage, amperage arrangement. As mentioned above, each high capacity battery may be capable of storing up to approximately 150 kWh using conventional technology. The solar power canopy 100, however, may store several such batteries.

Importantly, as can be appreciated, each of the cartridges, as described herein, may contain both the high capacity storage batteries as well as the electronics to connect the same to the loads and means for dissipating heat.

Other uses for the technology include, among other things having the external unit be an electric vehicle charger to allow for high capacity charging of electric vehicle batteries. This may be particularly useful in remote locations where access to national or State power grid is not available. The solar panels and high capacity batteries ensure the electric vehicle charger station would always have sufficient stored energy or available energy to charge an electric vehicle battery. Yet another use is for computing power, such as, for example, cryptocurrency mining computational power. Servers mining cryptocurrency, or solving the equations, use a tremendous amount of energy, but the servers may be intermittently turned off as needed. Thus, powering servers using the solar canopy renewable energy and/or stored energy allows for powering the servers to solve equations when power is available. For those solar canopies with connections to a national or State power grid, the servers could also be shut off when the national or State power grids are at peak or exceeded power demands such that additional power can be provide to the grid. The solar canopies also are uniquely suited to solve cryptocurrency equations for those currencies that require “GREEN” energy sources.

While suppling alternative electrical energy may reduce the on-peak demand of the associated unit to which the solar canopy is associated, whether the associated unit is a local building (commercial or residence) or grid, the high capacity storage batteries only store a portion of the overall energy need for the associated unit over the on-peak demand. That is to say, typically the high capacity storage batteries only provide reduced energy demands for a few hours of operation of most commercial buildings, which requires the commercial building to use grid power for the time the high capacity storage batteries cannot provide the full load of energy. In most cases, the high demands of the commercial building result from refrigerant systems, such as food storage, server room temperature control, or HVAC systems.

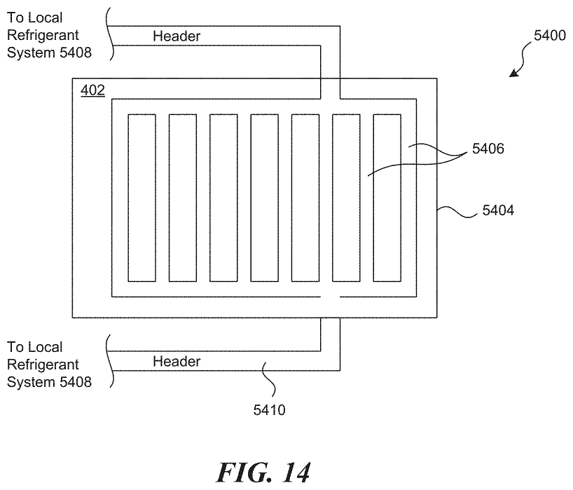

The technology of the present application provides that some of the plurality of cartridges include thermal storage cartridges 660, FIG. 11, that have equipment to store refrigerant energy. FIG. 14 provides some additional detail of the thermal storage cartridge 660, including equipment to store refrigerant energy. While FIG. 14 shows a cartridge only with equipment to store refrigerant energy, the cartridge may include the energy storage equipment described above as well as thermal storage cartridge equipment.

In certain embodiments of the technology, the cartridge 660 houses a refrigerant energy storage tank 1400 filled with a working fluid, which may be, for example, water, salt water, certain waxes, or other material that experiences a phase change at the working temperature and pressure. The refrigerant energy storage tank 1400 would include insulation 1404 to retain the energy within the tank as much as possible. The refrigerant energy storage tank 1400 includes one or more fluid conduits 1406, which may be coils. The fluid conduits would be in fluid communication with a local refrigerant system 1408 of an HVAC or refrigerant system, which is not shown but generally understood in the art, through a conduit or pipe. The local refrigerant system 1408 would have a refrigerant fluid 1410 that would flow into and out of the refrigerant energy storage tank 1400 through the fluid conduits 1406.

During off-peak demand times, the refrigerant energy storage tank 1400 would evaporate the refrigerant fluid 1410, which would take heat from the working fluid causing the working fluid to become a liquid or a solid (depending on the phase change temperature). In the case of water, or salt-water, the working fluid would change to ice during off-peak demand times. This process stores refrigerant energy in the refrigerant energy storage tank 1400 (the energy storage is generally referred to as the latent heat of phase change). Generally, the compressor of the HVAC system or refrigerant system operates to cause the working fluid 1410 to change from water to ice in this exemplary working fluid example. The compressor of the HVAC or refrigerant system, however, is operating during off-peak demand when energy is more economical.

As explained above, the refrigerant fluid 1410 is used in refrigerant energy storage tank 1400 to add or remove energy from the working fluid. Certain embodiments of the technology, however, may require additional separation between the refrigerant energy storage tank 1400 and the refrigerant fluid 1410. To facilitate the additional separation, a vapor compression cycle including compressors, pumps, evaporator, pipes, and valves may be incorporated into the cartridges 660.

During on-peak demand times, the stored refrigerant energy is released back to the HVAC system by reversing the process and releasing heat from the refrigerant fluid 1410 to the working fluid causing the working fluid to become a gas or a liquid (again depending on the phase change temperature). In the case of ice, the working fluid would phase change from ice to water, or salt-water. While releasing the stored refrigerant energy back to the HVAC system or refrigerant system, the compressor of the HVAC system or refrigerant system will ideally be idle or operate minimally during time of on-peak demand times.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I claim:

1. An energy storage canopy comprising:
at least one vertical support and at least one horizontal support coupled;
a roof having a top surface configured to face a sun and a bottom surface configured to face a ground;
at least one solar panel coupled to the roof above the top surface;
an energy storage cartridge comprising at least storage battery;
at least one power connector operatively coupled to the energy storage cartridge; the at least one power connector assembly comprising:
an articulating arm having a proximal end coupled to the solar canopy and a distal end opposite the proximal end;
a power cord; and
a plug assembly coupled to the distal end of the articulating arm wherein the plug assembly is configured to couple to an electric vehicle to charge a battery of the electric vehicle.

2. The energy storage canopy of claim 1 wherein the power cord is extendable from and retractable into the articulating arm.

3. The energy storage canopy of claim 1 wherein the plug assembly comprises a plug and a display.

4. The energy storage canopy of claim 3 wherein the display comprises a graphical user interface configured to display charge and price data.

5. The energy storage canopy of claim 1 wherein the articulating arm comprises an anchor portion and an upper arm portion rotatable coupled to the anchor portion.

6. The energy storage canopy of claim 5 wherein the articulating arm comprises a lower arm portion pivotably coupled to the upper arm portion.

7. The energy storage canopy of claim 1 wherein the articulating arm has a pull member coupled to the distal end.

8. The energy storage canopy of claim 7 wherein the articulating arm is biased to be located in proximity to the bottom surface of the roof.

9. The energy storage canopy of claim 6 comprising a first motor to control the rotation of the upper arm portion with respect to the anchor portion.

10. The energy storage canopy of claim 9 comprising a second motor to control the pivoting of the lower arm portion with respect to the upper arm portion.

11. The energy storage canopy of claim 10 comprising a computer to control the first and second motor wherein the computer is configured to cause the plug assembly to electrically couple the energy storage cartridge to the electric vehicle battery.

12. The energy storage canopy of claim 11 wherein the computer is configured to receive input from at least one sensor selected from the group of sensors including magnetic sensors, optical sensors, touch sensors, radio frequency sensors, or a combination thereof.

13. An energy storage canopy comprising:
a roof;
a photovoltaic cell coupled to the roof and configured to generate electrical energy;
at least one electric vehicle charging cartridge comprising at least one storage battery and a power control system configured to allow the at least one storage battery to charge a battery of an electric vehicle;
a retractable power cord mechanically coupled to the energy storage canopy and electrically coupled to the at least one electric vehicle charging cartridge; and
a plug assembly coupled to the retractable power cord configured to couple to an electric vehicle; and
a pull member operatively coupled to the retractable power cord such that a user can pull the pull member to cause the retractable cord to extend.

14. The energy storage canopy of claim 13 wherein the plug assembly comprises at least one plug and a display.

15. The energy storage canopy of claim 13 wherein the retractable power cord is mechanically coupled to the energy storage canopy by an articulating arm.

16. The energy storage canopy of claim 15 comprising a means for moving the articulating arm.

17. The energy storage canopy of claim 16 wherein the means is a pull member.

18. The energy storage canopy of claim 16 wherein the means is at least one member.

19. An energy storage canopy comprising:
a photovoltaic cell coupled to the energy storage canopy and configured to generate electrical energy;
at least one energy storage cartridge comprising at least one storage battery and a power control system configured to allow the at least one storage battery to a load;
a plug assembly configured to couple to an electric vehicle; and
means of electrically coupling a plug assembly to the at least one energy storage cartridge such that the at least one energy storage cartridge can charge a battery of an electric vehicle.

20. The means of electrically coupling the plug assembly to the at least one energy storage cartridge comprises an articulating arm.
